(19) United States
(12) Patent Application Publication
(10) Pub. No.: US 2020/0316578 A1
(43) Pub. Date: Oct. 8, 2020

(54) FILTER CATALYST, EXHAUST GAS PURIFICATION DEVICE, AND METHOD FOR MANUFACTURING FILTER CATALYST

(71) Applicants: Naoto MIYOSHI, Toyota-shi (JP); Koji SUGIURA, Toyota-shi (JP); Hiromasa NISHIOKA, Toyota-shi (JP); Akemi SATO, Toyota-shi (JP); Masatoshi IKEBE, Kakegawa-shi (JP); Ryota NAKASHIMA, Kakegawa-shi (JP); Yasutaka NOMURA, Kakegawa-shi (JP); Hirotaka ORI, Kakegawa-shi (JP)

(72) Inventors: Naoto MIYOSHI, Nagoya-shi (JP); Hiromasa NISHIOKA, Susono-shi (JP); Koji SUGIURA, Toyota-shi (JP); Akemi SATO, Toyota-shi (JP); Masatoshi IKEBE, Kakegawa-shi (JP); Ryota NAKASHIMA, Kakegawa-shi (JP); Yasutaka NOMURA, Kakegawa-shi (JP); Hirotaka ORI, Kakegawa-shi (JP)

(73) Assignees: TOYOTA JIDOSHA KABUSHIKI KAISHA, Toyota-shi (JP); CATALER CORPORATION, Kakegawa-shi (JP)

(21) Appl. No.: 16/818,239

(22) Filed: Mar. 13, 2020

(30) Foreign Application Priority Data
Apr. 4, 2019 (JP) 2019-071930

(51) Int. Cl. B01J 35/04; B01D 53/88

(52) U.S. Cl. CPC B01J 35/04; B01D 2255/908; B01D 2255/9155; B01D 53/885

(57) ABSTRACT

There is provided a filter catalyst that has a wall-flow structure, and the filter catalyst has an excellent purification performance. The embodiment is a filter catalyst including a wall-flow type substrate that includes an inlet-side cell, an outlet-side cell, and a partition wall. The inlet-side cell has an open end portion on an exhaust gas flow-in side and a closed end portion on an exhaust gas flow-out side. The outlet-side cell is adjacent to the inlet-side cell and has an open end portion on the exhaust gas flow-out side and a closed end portion on the exhaust gas flow-in side. The partition wall has a porous structure and interposes between the inlet-side cell and the outlet-side cell. The filter catalyst includes an oxygen occlusion portion and a catalyst portion dispersed and disposed in the porous structure. The oxygen occlusion portion is disposed on a wall surface of the porous structure. The catalyst portion is disposed on the oxygen occlusion portion, and the catalyst portion has a surface exposed to a space where an exhaust gas flows including a communication hole.

### CROSS REFERENCE TO RELATED APPLICATIONS

The present application claims priority from Japanese patent application JP 2019-071930 filed on Apr. 4, 2019, the content of which is hereby incorporated by reference into this application.

### BACKGROUND

### Technical Field

The present disclosure relates to a filter catalyst. The present disclosure also relates to an exhaust gas purification device including the filter catalyst. The present disclosure also relates to a method for manufacturing the filter catalyst.

### Background Art

Generally, it has been known that an exhaust gas discharged from an internal combustion engine contains a particulate matter (PM) containing carbon as the main component, ash made of an incombustible component, and the like, and the exhaust gas causes air pollution. Therefore, an emission amount of the particulate matter has been regulated tighter every year together with components, such as hydrocarbons (HC), carbon monoxide (CO), and nitrogen oxides (NOx), contained in the exhaust gas. Therefore, there has been proposed a technique to trap and remove this particulate matter from the exhaust gas.

One of the techniques to trap the particulate matter is a particulate filter. This particulate filter is disposed in an exhaust passage of the internal combustion engine. For example, while it is less than a diesel engine does, a gasoline engine emits a certain amount of particulate matter together with the exhaust gas. Therefore, a gasoline particulate filter (GPF) is mounted in the exhaust passage. As such a particulate filter, those having a structure referred to as a wall-flow type is known. The wall-flow type has a substrate including multiple porous cells, and the multiple cells have alternately closed inlets and outlets. In the wall-flow type particulate filter, the exhaust gas flown in from the cell inlet passes through partitioned porous cell partition walls, and is discharged to the cell outlet. While the exhaust gas passes through the porous cell partition walls, the particulate matter is trapped in the partition walls.

In recent years, it has been examined to cause the above-described particulate filter to support a noble metal catalyst in order to further improve a purification performance.

For example, JP 2016-77980 A proposes an exhaust gas purification device that is disposed in an exhaust passage of the internal combustion engine and purifies an exhaust gas discharged from an internal combustion engine. The exhaust gas purification device includes a substrate, a first catalyst portion, and a second catalyst portion. The substrate in a wall-flow structure has an entry-side cell in which only an exhaust gas inflow-side end part is open, an exit-side cell that is adjacent to the entry-side cell and has only an exhaust gas out-flow-side end part is open, and a porous partition that partitions into the entry-side cell and the exit-side cell. The first catalyst portion is formed in a small pore having a relatively small pore diameter among internal pores of the partition. The second catalyst portion is formed to be a large pore having a relatively large pore diameter among the internal pores of the partition. The first catalyst portion contains a support and one or two noble metals of any one of Pt, Pd or Rh supported by the support. The second catalyst portion contains a support and one or two noble metals of any one of Pt, Pd or Rh supported by the support at least other than the noble metal contained in the first catalyst portion. JP 2016-77980 A discloses that this technique ensures providing an exhaust gas purification device that ensures improving a purification performance of the exhaust gas while achieving a reduction of a pressure loss.

### SUMMARY

JP 2016-77980 A discloses that the catalyst portion is formed on a wall surface in the small pore. However, the exhaust gas is difficult to diffuse deep into the small pore. Therefore, it is concerned that a performance of the catalyst may fail to be fully demonstrated. Therefore, there has been demanded a further improved purification performance.

The present disclosure provides a filter catalyst having a wall-flow structure, and the filter catalyst has an excellent purification performance.

An aspect of the present embodiment is as follows.

(1) A filter catalyst including a wall-flow type substrate that includes an inlet-side cell, an outlet-side cell, and a partition wall, the inlet-side cell having an open end portion on an exhaust gas flow-in side and a closed end portion on an exhaust gas flow-out side, the outlet-side cell being adjacent to the inlet-side cell and having an open end portion on the exhaust gas flow-out side and a closed end portion on the exhaust gas flow-in side, the partition wall having a porous structure and interposing between the inlet-side cell and the outlet-side cell; and

an oxygen occlusion portion and a catalyst portion dispersed and disposed in the porous structure,

wherein the oxygen occlusion portion is disposed on a wall surface of the porous structure, and

wherein the catalyst portion is disposed on the oxygen occlusion portion, and the catalyst portion has a surface exposed to a space where an exhaust gas flows including a communication hole.

(2) The filter catalyst according to (1),

wherein the oxygen occlusion portion and the catalyst portion are each dispersed over the whole porous structure.

(3) An exhaust gas purification device including

the filter catalyst according to (1) or (2).

(4) A method for manufacturing the filter catalyst according to (1) or (2), including:

dispersing and disposing a slurry for an oxygen occlusion portion containing an oxygen occlusion material and a solvent in the partition wall;

disposing a slurry for a catalyst portion containing a catalytic metal, a catalyst carrier, and a solvent in the porous structure where the slurry for the oxygen occlusion portion is disposed and on the slurry for the oxygen occlusion portion; and

sintering the substrate including the slurry for the oxygen occlusion portion and the slurry for the catalyst portion.

(5) The method for manufacturing the filter catalyst according to (4), including

drying the slurry for the oxygen occlusion portion before disposing the slurry for the catalyst portion in the porous structure.

(6) A method for manufacturing a filter catalyst, including:

preparing a wall-flow type substrate that includes an inlet-side cell, an outlet-side cell, and a partition wall, the inlet-side cell having an open end portion on an exhaust gas flow-in side and a closed end portion on an exhaust gas flow-out side, the outlet-side cell being adjacent to the inlet-side cell and having an open end portion on the exhaust gas flow-out side and a closed end portion on the exhaust gas flow-in side, the partition wall having a porous structure and interposing between the inlet-side cell and the outlet-side cell;

dispersing and disposing a first slurry containing an oxygen occlusion material and a solvent in the partition wall;

disposing a second slurry containing a catalytic metal, a catalyst carrier, and a solvent in the porous structure where the first slurry is disposed and on the first slurry; and

sintering the substrate including the first slurry and the second slurry.

(7) The method for manufacturing a filter catalyst according to claim 6, wherein a viscosity of the second slurry is greater than a viscosity of the first slurry.

The present disclosure ensures providing a filter catalyst that has a wall-flow structure, and the filter catalyst has an excellent purification performance.

### BRIEF DESCRIPTION OF THE DRAWINGS

FIG. 1 is a schematic perspective view illustrating a structure of a filter catalyst according to an embodiment;

FIG. 2 is a schematic cross-sectional view illustrating a cross-sectional surface of the filter catalyst according to the embodiment;

FIG. 3 is a schematic cross-sectional view of a portion corresponding to a region IV in FIG. 2;

FIG. 4 is a drawing schematically illustrating an exhaust gas purification device according to the embodiment;

FIG. 5 illustrates an image obtained by observing a dispersed state of a coating material on a cross-sectional surface of a filter catalyst E1 using an electron probe micro analyzer (EPMA);

FIG. 6 is a graph illustrating 50% purification temperatures of filter catalysts E1 to E2 and C1 to C2 obtained in Examples and Comparative examples; and

FIG. 7 is a graph illustrating oxygen occlusion amounts of the filter catalyst E1 to E2 and C1 to C2 obtained in the Examples and the Comparative examples.

### DETAILED DESCRIPTION

The embodiment is a filter catalyst including a wall-flow type substrate that includes an inlet-side cell, an outlet-side cell, and a partition wall. The inlet-side cell has an open end portion on an exhaust gas flow-in side and a closed end portion on an exhaust gas flow-out side. The outlet-side cell is adjacent to the inlet-side cell and has an open end portion on the exhaust gas flow-out side and a closed end portion on the exhaust gas flow-in side. The partition wall has a porous structure and interposes between the inlet-side cell and the outlet-side cell. The filter catalyst includes an oxygen occlusion portion and a catalyst portion dispersed and disposed in the porous structure. The oxygen occlusion portion is disposed on a wall surface of the porous structure. The catalyst portion is disposed on the oxygen occlusion portion, and the catalyst portion has a surface exposed to a space where an exhaust gas flows including a communication hole.

In the filter catalyst according to the embodiment, the oxygen occlusion portion and the catalyst portion are dispersed and disposed in the porous structure of the partition wall. The oxygen occlusion portion is disposed on the wall surface of the porous structure, and the catalyst portion is disposed on the oxygen occlusion portion. Such a configuration ensures bringing the catalyst portion close to a flow of the exhaust gas and efficiently bringing the catalyst portion into contact with the flow of the exhaust gas. The oxygen occlusion portion is disposed on the wall surface of the porous structure and the catalyst portion is formed on the oxygen occlusion portion, and therefore, the oxygen occlusion portion is disposed in a portion where a direct contact to the flow of the exhaust gas is difficult. However, the oxygen occlusion portion can provide oxygen occlusion capability even though the oxygen occlusion portion is disposed in such a far side, thereby ensuring providing a stable catalyst performance. Furthermore, in the filter catalyst according to the embodiment, the catalyst portion is disposed in a state of being dispersed along the flow of the exhaust gas, and therefore, the exhaust gas is efficiently brought in contact with the catalyst portion. As a result, an excellent purification performance can be obtained. Accordingly, with the embodiment, a filter catalyst that has an excellent exhaust gas purification performance can be provided.

The following describes the embodiment with reference to the drawings.

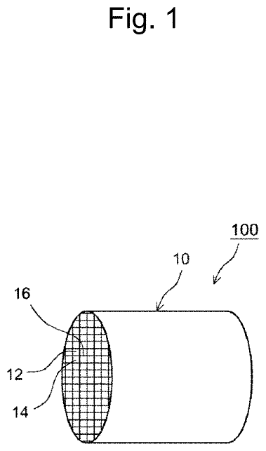

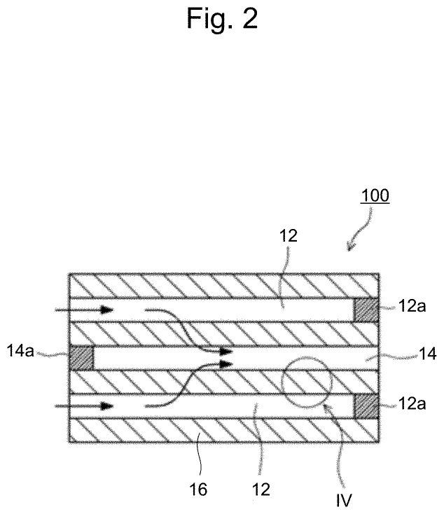

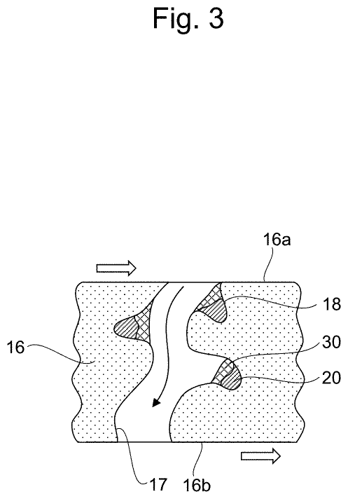

FIG. 1 is a schematic perspective view illustrating a structure of a filter catalyst 100. FIG. 2 is a schematic cross-sectional view that enlarges a part of a cross-sectional surface cut off on a surface parallel to the axial direction of the filter catalyst 100. FIG. 3 is a schematic cross-sectional view of a portion corresponding to a region IV in FIG. 2, and is a schematic cross-sectional view illustrating a structure of a communication hole in a partition wall. As illustrated in FIGS. 1 to 3, the filter catalyst 100 includes a substrate 10 having a wall-flow structure, oxygen occlusion portions 20, and catalyst portions 30. The substrate 10 includes inlet-side cells 12, outlet-side cells 14, and porous partition walls 16. The inlet-side cell 12 has an open end portion on an exhaust gas flow-in side and a closed end portion on an exhaust gas flow-out side. The outlet-side cell 14 is adjacent to the inlet-side cell 12, and has an open end portion on the exhaust gas flow-out side and a closed end portion on the exhaust gas flow-in side. The partition wall 16 partitions into the inlet-side call 12 and the outlet-side cell 14. As illustrated in FIG. 2, the end portion on the exhaust gas flow-in side of the inlet-side cell 12 is open, and the end portion on the exhaust gas flow-out side is sealed by a sealing portion 12a. The outlet-side cell 14 is adjacent to the inlet-side cell 12. The end portion on the exhaust gas flow-out side of the outlet-side cell 14 is open, and the end portion on the exhaust gas flow-in side is sealed by a sealing portion 14a.

The partition wall 16 has a porous structure, and spatially communicates with the inlet-side cell 12 and the outlet-side cell 14. In the partition wall 16, intricate passages caused by a plurality of pores are formed. This intricate passage forms portions where the exhaust gas easily flows and portions where the exhaust gas has difficulty in flowing.

For example, the partition wall 16 has communication holes formed by connections of the multiple pores and constituted to communicate with a front surface 16a and a back surface 16b of the partition wall. Note that, in the description, a wall surface facing the inlet-side cell 12 on the partition wall is referred to as the front surface (16a), and a wall surface facing the outlet-side cell 14 is referred to as the back surface (16b). Generally, such a communication hole is a portion where the exhaust gas easily flows.

For example, the partition wall 16 may have non-communication holes that connect to the communication hole, or the front surface or the back surface of the partition wall. This non-communication hole means a hole portion that does not function as the communication hole. Generally, such a non-communication hole is a portion where the exhaust gas has difficulty in flowing. As described above, since the communication hole is formed by the connections of the multiple pores, there may be the portion where the exhaust gas has difficulty in flowing depending on the shape even in the communication hole. For example, a deep portion in a recess, such as a drift region, is the portion where the exhaust gas has difficulty in flowing. In the embodiment, the oxygen occlusion portion is formed in such a portion where the exhaust gas has difficulty in flowing.

FIG. 3 is the schematic cross-sectional view illustrating a structure of the communication hole in the partition wall as described above, and schematically illustrates an exemplary structure in which a plurality of non-communication holes 18 are formed in a communication hole 17. Note that FIG. 3 is a conceptual diagram simply illustrated to easily describe the structure of the embodiment, and does not limit the embodiment. In FIG. 3, three non-communication holes 18 opened to the communication hole 17 are illustrated. Such non-communication holes 18 may exist on the front surface of the partition wall or also on the back surface. The communication hole 17 has a relatively large pore diameter compared with that of the non-communication hole 18. The non-communication hole 18 has a relatively small pore diameter compared with the communication hole 17. In the non-communication hole 18, an oxygen occlusion portion 20 and a catalyst portion 30 are formed. The oxygen occlusion portion 20 is disposed in a far-side (bottom side) of the non-communication hole 18, and the catalyst portion 30 is disposed on the oxygen occlusion portion 20 (opening side). The catalyst portion 30 has a surface exposed to the communication hole 17 and easily contacts the flow of the exhaust gas. Note that, while FIG. 3 illustrates a configuration in which the oxygen occlusion portion 20 and the catalyst portion 30 are disposed in the non-communication hole 18, the embodiment is not limited to this configuration.

In the filter catalyst 100 having such a configuration, the exhaust gas discharged from the internal combustion engine flows into the inlet-side cells 12 from the end portion on the exhaust gas flow-in side. The exhaust gas passes through the communication holes of the partition walls 16 having the porous structure to enter the adjacent outlet-side cells 14, and flows out of the filter catalyst from the end portion on the exhaust gas flow-out side. In the filter catalyst 100, the exhaust gas mainly contacts the catalyst portions 30 while passing through the partition walls 16, and this converts (detoxifies) harmful components in the exhaust gas. As described above, the catalyst portion 30 is disposed in the portion where it is easy to directly contact the flow of the exhaust gas (for example, near opening of the non-communication hole 18), thereby ensuring the efficient contact with the exhaust gas. The oxygen occlusion portion 20 is disposed in the portion where it is relatively difficult to be contacted by the exhaust gas (for example, bottom side of the non-communication hole 18), thereby securing oxygen occlusion capability and ensuring bringing the catalyst portion 30 close to the flow of the exhaust gas. Therefore, the filter catalyst 100 according to the embodiment can have an excellent purification performance of the exhaust gas.

Note that, for example, HC components and CO components contained in the exhaust gas are oxidized by a catalyst function of the catalyst portion to be converted into water (H₂O), carbon dioxide (CO₂), and the like (purification). NOx components are reduced by the catalyst function of the catalyst portion to be converted into nitrogen (N₂) (purification). PM components are difficult to pass through the communication holes 17 of the partition walls 16, and therefore, generally accumulate on the partition walls 16 in the inlet-side cell 12. The accumulated PM is decomposed by the catalyst function of the catalyst portion that can exist on the surface of the partition wall or by being burnt at a predetermined temperature (for example, approximately 500 to 700° C.) (purification).

The following describes the substrate, the oxygen occlusion portion, and the catalyst portion.

<Substrate>

Conventional ones made of various kinds of materials and in various kinds of forms used in this kind of usage are usable as a substrate. For example, a substrate formed of a ceramic or an alloy (such as stainless steel) of, for example, cordierite or silicon carbide (SiC) can be used. The exemplary shapes of the substrate include, for example, a cylindrical shape, an elliptical cylindrical shape, or a polygonal cylindrical shape, and may be in the cylindrical shape.

The inlet-side cell and the outlet-side cell may be set into appropriate shape and size considering the flow rate and the components of the exhaust gas supplied to the filter catalyst. The shapes of the inlet-side cell and the outlet-side cell are not particularly limited, and the exemplary shapes include geometric shapes, such as a quadrilateral, such as a square shape, a parallelogram, a rectangular, and a trapezoidal shape, a triangular shape, another polygonal shape (for example, hexagonal shape and octagonal shape), and a circular shape.

The partition wall is formed between the inlet-side cell and the outlet-side cell that are neighboring, and the inlet-side cell and the outlet-side cell are partitioned by this partition wall. The partition wall has a porous structure through which the exhaust gas is passable. The inlet-side cell and the outlet-side cell spatially communicate through the porous structure.

While porosity of the partition wall is not particularly limited, it is, for example, approximately 40% to 70%, and may be 50% to 65%. When the porosity of the partition wall is too small, there are some cases that the pressure loss increases. Meanwhile, when the porosity of the partition wall 16 is too large, mechanical strength of the filter catalyst lowers. While a thickness of the partition wall is not particularly limited, it is, for example, approximately 200 μm to 400 μm. Setting the thickness of the partition wall to fall within such a range ensures suppressing the increase of the pressure loss without impairing trap efficiency of PM. Note that any lower-limit values can be combined with any upper-limit values, and also, a predetermined range can be specified by combining lower-limit values or upper-limit values.

Since the communication hole as described above communicates through the partition wall in the thickness direction, the exhaust gas smoothly passes through the communication hole. The pore diameter of the communication hole is larger than the pore diameter of the non-communication hole. Note that, while multiple communication holes exist in the partition wall before coating, non-communication holes may be newly generated due to pores being covered by coating the material. The communication hole can be determined by analyzing a three-dimensional structure model prepared by an X-ray CT.

<Oxygen Occlusion Portion>

The oxygen occlusion portion includes an oxygen occlusion material (Oxygen Storage Capacity (OSC) material) having the oxygen occlusion capability. The oxygen occlusion material occludes the oxygen in the exhaust gas when an air-fuel ratio of the exhaust gas is lean (that is, atmosphere having an excessive oxygen), and emits the occluded oxygen when the air-fuel ratio of the exhaust gas is rich (that is, atmosphere having an excessive fuel). The oxygen occlusion material is not particularly limited, and the exemplary oxygen occlusion materials include, for example, cerium oxide (ceria: CeO₂) or composite oxide containing ceria (for example, ceria-zirconia composite oxide (CeO₂—ZrO₂ composite oxide). Among these, the CeO₂—ZrO₂ composite oxide has high oxygen occlusion capability, and may be used as the oxygen occlusion material. The content of the oxygen occlusion material is, for example, 40 mass % or more, may be 50 mass % or more, may be 70 mass % or more, may be 80 mass % or more, and may be 90 mass % or more, based on the total mass of the oxygen occlusion portion. In the filter catalyst according to the embodiment, the oxygen occlusion material is disposed in a dispersed state along the flow of the exhaust gas in the partition wall, and thus, the oxygen in the exhaust gas passing through the partition wall can be efficiently absorbed and emitted. Note that the oxygen occlusion portion can provide the oxygen occlusion capability even when the oxygen occlusion portion is disposed in the portion where the exhaust gas has difficulty in flowing (for example, far-side of non-communication hole). Therefore, further stable catalyst performance can be obtained to improve the purification performance of the catalyst.

The oxygen occlusion portion is dispersed and disposed in the porous structure, and is disposed on the wall surface of the porous structure. The oxygen occlusion portion may be disposed in the portion where the exhaust gas has difficulty in flowing in the porous structure. Arranging the oxygen occlusion portion in the portion where the exhaust gas has difficulty in flowing ensures effectively using the portion where the exhaust gas has difficulty in flowing as a space that can occlude oxygen, and ensures bringing the catalyst portion disposed on the oxygen occlusion portion close to the flow of the exhaust gas.

For example, in one aspect of the embodiment, the oxygen occlusion portion is disposed in the above-described non-communication hole. Arranging the oxygen occlusion portion in the non-communication hole ensures effectively using the non-communication hole where the exhaust gas has difficulty in flowing as the space to occlude oxygen, and ensures bringing the catalyst portion disposed on the oxygen occlusion portion close to the flow of the exhaust gas, and as the result, the purification performance can be improved.

The oxygen occlusion portion substantially does not include catalytic metal in some embodiments. “[S]ubstantially not include” means that the content of the catalytic metal in the oxygen occlusion portion is, for example, 0.5 mass % or less, may mean 0.1 mass % or less, may mean 0.01 mass % or less, based on the total mass of the oxygen occlusion portion, and may mean that no catalytic metal is detected.

The oxygen occlusion portion may contain other components besides the oxygen occlusion material. For example, the oxygen occlusion portion may contain metal oxide (non-oxygen occlusion material). The exemplary metal oxides include, for example, alumina (specifically, stabilized alumina), zirconia, and zeolite. The content of the metal oxide is, for example, 0 to 50 mass %, and may be 0.1 to 30 mass %, based on the total mass of the oxygen occlusion portion. Exemplary other components include, for example, components derived from a binder. Note that any lower-limit values can be combined with any upper-limit values, and also, a predetermined range can be specified by combining lower-limit values or upper-limit values.

<Catalyst Portion>

The catalyst portion includes a catalyst carrier supporting the catalytic metal, and is dispersed and disposed in the porous structure. The catalyst portion is disposed on the oxygen occlusion portion. The surface of the catalyst portion is exposed in a space, representatively including the communication holes, where the exhaust gas flows. The catalyst portion is disposed on the oxygen occlusion portion, thereby being brought further close to the flow of the exhaust gas. Therefore, in the embodiment, the catalyst portion can efficiently contact the flow of the exhaust gas.

In one aspect of the embodiment, the catalyst portion is disposed on the oxygen occlusion portion disposed in the above-described non-communication hole. Filling the oxygen occlusion portion in the non-communication hole and forming the catalyst portion on the oxygen occlusion portion inevitably brings the catalyst portion close to the communication hole where the exhaust gas flows. Therefore, the contact of the catalyst portion with the exhaust gas is promoted to improve the catalyst performance. More specifically, in one aspect of the embodiment, the catalyst portion is disposed on the oxygen occlusion portion, which is disposed in the non-communication hole, and on the opening side. That is, in one aspect of the embodiment, the oxygen occlusion portion is disposed on a bottom side in the non-communication hole, and the catalyst portion is disposed on the opening side in the non-communication hole.

The catalyst portion includes the catalytic metal. The catalytic metal is not particularly limited, and metal that is functionable as an oxidation catalyst and a reduction catalyst can be used. The exemplary catalytic metals include, typically, noble metal, such as rhodium (Rh), palladium (Pd), and platinum (Pt) in the platinum group. Ruthenium (Ru), osmium (Os), iridium (Ir), gold (Au), argentum (Ag), copper (Cu), nickel (Ni), iron (Fe) or cobalt (Co), or an alloy of the above-described noble metal and these metals is included. One kind of the catalytic metal alone may be used, or two or more kinds of the catalytic metal may be combined and used.

The catalytic metal may be used as microparticles with sufficiently small grain diameter from the aspect of increasing contact area with the exhaust gas. The average grain diameter (average value of grain diameter obtained by TEM observation) of the catalyst metal particles is, for example, 1 to 15 nm, and may be 10 nm or less, 7 nm or less, or 5 nm or less. Note that any lower-limit values can be combined with any upper-limit values, and also, a predetermined range can be specified by combining lower-limit values or upper-limit values.

Supported amount of the catalytic metal is not particularly limited. The content of the catalytic metal in the catalyst portion per 1 L of volume of the substrate is, for example, 0.1 g to 5 g, and may be 0.3 g to 2 g. When the content of the catalytic metal is too small, the catalytic activity is insufficient. Meanwhile, when the content of the catalytic metal is too large, grain growth easily occurs in the catalytic metal, and simultaneously, it is also disadvantageous from the aspect of cost. Note that any lower-limit values can be combined with any upper-limit values, and also, a predetermined range can be specified by combining lower-limit values or upper-limit values.

The content of the catalytic metal is, for example, 0.1 to 5 mass %, and may be 0.3 to 2 mass %, based on the total mass of the catalyst portion. Note that any lower-limit values can be combined with any upper-limit values, and also, a predetermined range can be specified by combining lower-limit values or upper-limit values.

The catalyst carrier to support the catalytic metal is not particularly limited. The exemplary catalyst carriers (typically, in a particle shape) include, for example, metal oxide, such as alumina (Al₂O₃), zirconia (ZrO₂), ceria (CeO₂), silica (SiO₂), magnesia (MgO), and titanium oxide (titania: TiO₂), or a solid solution of these (for example, ceria-zirconia (CeO₂—ZrO₂) composite oxide). One kind of the catalytic metal alone may be used, or two or more kinds of the catalytic metal may be combined and used. Note that the above-described catalyst carrier may be added with another material (typically, inorganic oxide) as an accessory component. As substances that can be added to the catalyst carrier, rare earth element, such as lanthanum (La) and yttrium (Y), alkaline-earth elements, such as calcium, other transition metal elements, and the like may be used. Among those described above, the rare earth element, such as lanthanum and yttrium, can improve a specific surface area at a high temperature without inhibiting the catalyst function, thereby being suitably used as a stabilizing agent.

The specific surface area of the catalyst carrier is, for example, 10 to 500 m²/g, may be 20 to 200 m²/g from the aspect of heat resistance and structural stability. The average grain diameter of the catalyst carrier is, for example, 0.1 to 50 μm, and may be 0.3 to 10 μm. Note that any lower-limit values can be combined with any upper-limit values, and also, a predetermined range can be specified by combining lower-limit values or upper-limit values.

A method that causes the catalyst carrier to support the catalytic metal is not particularly limited. For example, after immersing the above-described catalyst carrier in the water solution containing metal salt (for example, Pt salt (for example, nitrate)) or metal complex (for example, Pt complex (for example, dinitrodiammine complex)), the catalyst carrier is dried and sintered, and thus, a catalyst support carrier including a catalyst carrier that supports the catalytic metal can be prepared.

The catalyst portion may include the metal oxide (non-oxygen occlusion material) that does not support the catalytic metal. The exemplary metal oxides include, for example, alumina (for example, stabilized alumina). The content rate of the metal oxide is, for example, 20 mass % to 50 mass %, and may be 30 mass % to 40 mass %. Note that any lower-limit values can be combined with any upper-limit values, and also, a predetermined range can be specified by combining lower-limit values or upper-limit values.

The catalyst portion may include the oxygen occlusion material. The content of the oxygen occlusion material is, for example, 10 to 50 mass %, may be 20 to 45 mass %, and may be 30 to 40 mass %, based on the total mass of the catalyst portion. When the oxygen occlusion material is included in the catalyst portion, the catalytic activity or the durability improves, in some cases. Note that any lower-limit values can be combined with any upper-limit values, and also, a predetermined range can be specified by combining lower-limit values or upper-limit values.

<Method for Forming Oxygen Occlusion Portion and Catalyst Portion>

The oxygen occlusion portion and the catalyst portion can be formed using a slurry. Specifically, a slurry for the oxygen occlusion portion (also referred to as a first slurry) in order to form the oxygen occlusion portion and a slurry for the catalyst portion (also referred to as a second slurry) in order to form the catalyst portion are prepared.

The slurry for the oxygen occlusion portion can contain an oxygen occlusion material, a binder, and a solvent. The solvent is, for example, water. Containing the binder can appropriately bring the slurry for the oxygen occlusion portion into a close contact with the porous structure. The exemplary binders include, for example, alumina sol or silica sol.

The slurry for the oxygen occlusion portion may have a viscosity, a solid content rate, a particle diameter of the oxygen occlusion material, and the like appropriately adjusted to the extent that the slurry flows into the portion where the exhaust gas has difficulty in flowing (for example, non-communication hole and pore that has small pore diameter to easily become non-communication hole). For example, the viscosity (or surface tension) of the slurry for the oxygen occlusion portion is set low such that the slurry easily flows into the non-communication holes and the small pores. There are countless pores in the porous structure of the partition wall, and setting the viscosity of the slurry for the oxygen occlusion portion low, to the extent that the slurry for the oxygen occlusion portion flows into such non-communication holes and small pores, ensures efficiently flowing the slurry for the oxygen occlusion portion into the portions where the exhaust gas has difficulty in flowing including the non-communication holes.

The slurry for the catalyst portion can contain a catalyst carrier that supports the catalytic metal (catalyst support carrier), a binder, and a solvent. The solvent is, for example, water. Containing the binder ensures appropriately bringing the slurry for the catalyst portion into a close contact with the wall surface of the porous structure, the oxygen occlusion portion, or the like. The exemplary binders include, for example, alumina sol or silica sol.

As described above, the viscosity of the slurry changes according to a composition of the slurry, particle diameters of the contained components, and the like. The viscosity of the slurry is adjustable according to a manufacturing condition. For example, the viscosity increases by performing a wet grinding process to a dispersion liquid in which each component is dispersed. Therefore, appropriately adjusting this grinding condition can also adjust the viscosity of the slurry.

The following specifically describes a process to dispose the oxygen occlusion portion and the catalyst portion in a dispersed state in the porous structure. First, the slurry for the oxygen occlusion portion is filled inside the partition wall. Note that, as described above, the slurry for the oxygen occlusion portion may have the viscosity, the solid content rate, the particle diameter of the oxygen occlusion material, and the like appropriately adjusted to the extent that the slurry flows into the non-communication holes. The method for filling the slurry for the oxygen occlusion portion inside the partition wall is not particularly limited, and the exemplary methods include, for example, a method that immerses the substrate into the slurry for the oxygen occlusion portion and a method that draws the slurry for the oxygen occlusion portion into the substrate by vacuuming by decompression. After filling the slurry for the oxygen occlusion portion inside the partition wall, extra slurry is removed by spraying a pressured gas or vacuuming. When the slurry is partially removed, while the slurry in the portion where the exhaust gas easily flows is easily removed, the slurry in the portion where the exhaust gas has difficulty in flowing is difficult to be removed. Therefore, the slurry for the oxygen occlusion portion can be retained in the portion where the exhaust gas has difficulty in flowing. After being filled, the slurry for the oxygen occlusion portion can be dried. This ensures disposing the slurry for the oxygen occlusion portion in the dispersed state within the porous structure. Note that, after drying, sintering may be performed.

The non-communication hole has the relatively small pore diameter, thus being a portion where the slurry with low viscosity easily flows in due to capillarity. Therefore, filling the low viscosity slurry inside the partition wall causes the slurry to flow into the non-communication hole. From the non-communication hole, the slurry is difficult to flow out due to the capillarity. Therefore, spraying the pressured gas onto or vacuuming the substrate in which the slurry for the oxygen occlusion portion is filled easily removes the slurry for the oxygen occlusion portion from the communication holes and easily keeps the slurry for the oxygen occlusion portion in the non-communication hole. Therefore, the slurry for the oxygen occlusion portion can be preferentially disposed in the non-communication holes. Note that while this paragraph described filling of the slurry for the oxygen occlusion portion into the non-communication holes, the slurry is easily disposed in the portion where the exhaust gas has difficulty in flowing. The examples of such a portion include, for example, a pore with small pore diameter and a deep portion in a recess, such as a drift region, besides the non-communication hole.

Next, the slurry for the catalyst portion is filled inside the partition wall. Note that, as described above, the slurry for the catalyst portion may have the viscosity, the solid content rate, the particle diameter of the oxygen occlusion material, and the like appropriately adjusted to the extent that the slurry flows into the pores inside the partition wall. A method for filling the slurry for the catalyst portion inside the partition wall is not particularly limited, and the exemplary methods include, for example, a method that immerses the substrate into the slurry for the catalyst portion and a method that draws the slurry for the catalyst portion into the substrate by vacuuming by decompression. After filling the slurry for the catalyst portion inside the partition wall, the extra slurry is removed by spraying the pressured gas or vacuuming. As described above, the slurry in the portion where the exhaust gas easily flows is easily removed, and the slurry in the portion where the exhaust gas has difficulty in flowing is difficult to be removed. Therefore, the slurry for the oxygen occlusion portion can be retained in the portion where the exhaust gas has difficulty in flowing. After disposing the slurry for the catalyst portion, drying and sintering can be performed. This ensures forming the catalyst portion inside the porous structure and on the oxygen occlusion portion.

As described above, the non-communication hole and the small pore are the portions into which the slurry with low viscosity easily flows by the capillarity. Since the slurry for the oxygen occlusion portion (after drying) or the oxygen occlusion portion (after sintering) is already disposed in the non-communication holes and the small pores, the slurry for the catalyst portion is disposed on the slurry for the oxygen occlusion portion or the oxygen occlusion portion. In particular, using the slurry having high viscosity compared with the viscosity of the slurry for the oxygen occlusion portion easily forms the catalyst portion on the surface of the pore.

The slurry for the oxygen occlusion portion may be supplied into the substrate from the end portion on the exhaust gas flow-in side or the end portion on the exhaust gas flow-out side, or both of them. One kind of the slurry for the oxygen occlusion portion may be supplied into the substrate, or two kinds or more of the slurry for the oxygen occlusion portion may be supplied into the substrate. The slurry for the catalyst portion may be supplied into the substrate from the end portion on the exhaust gas flow-in side or the end portion on the exhaust gas flow-out side, or both of them. One kind of the slurry for the catalyst portion may be supplied into the substrate, or two kinds or more of the slurry for the catalyst portion may be supplied into the substrate.

In one aspect of the embodiment, a catalyst layer is not formed on the front surface and the back surface of the partition wall. The front surface and the back surface of the partition wall without the catalyst layer ensure suppressing the increase of the pressure loss. In one aspect of the embodiment, the catalyst layer may be formed on the front surface and/or the back surface of the partition wall. The front surface and/or the back surface of the partition wall with the catalyst layer ensure a further improved purification performance.

<Exhaust Gas Purification Device>

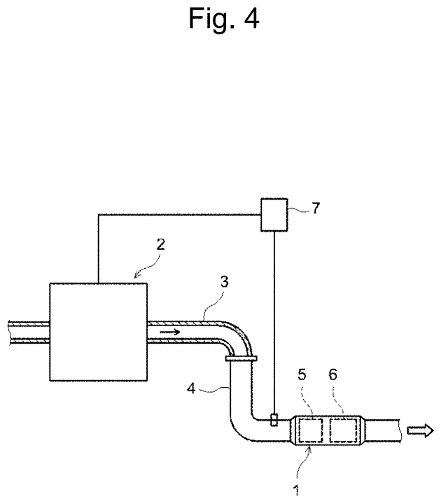

A description will be given of the configuration of the exhaust gas purification device according to the embodiment with reference to FIG. 4. FIG. 4 is a schematic diagram for describing an exemplary configuration of the exhaust gas purification device according to the embodiment. In FIG. 4, an exhaust gas purification device 1 is disposed in an exhaust system of the internal combustion engine 2.

An air-fuel mixture containing oxygen and fuel gas is supplied to the internal combustion engine (engine). The internal combustion engine burns this air-fuel mixture to convert a combustion energy into a mechanical energy. At this time, the burnt air-fuel mixture turns into an exhaust gas to be discharged to the exhaust system. The internal combustion engine 2 having a configuration illustrated in FIG. 4 is configured using a gasoline engine of an automobile as the main body.

The exhaust system of the above-described engine 2 will be described. An exhaust manifold 3 is coupled to an exhaust port (not illustrated) that communicates the above-described engine 2 with the exhaust system. The exhaust manifold 3 is coupled to an exhaust pipe 4 through which the exhaust gas flows and passes. The exhaust manifold 3 and the exhaust pipe 4 form an exhaust passage. The arrow in the drawing indicates the exhaust gas flowing direction.

The exhaust gas purification device 1 includes a catalyst member 5, a filter member (filter catalyst) 6, and an ECU 7. The exhaust gas purification device 1 converts (or decomposes) the harmful component (for example, carbon monoxide (CO), hydrocarbon (HC), and nitrogen oxides (NOx)) contained in the above-described discharged exhaust gas, and traps the particulate matter (PM) contained in the exhaust gas.

The catalyst member 5 is able to convert (or decompose) ternary components (NOx, HC, and CO) contained in the exhaust gas, and is disposed in the exhaust pipe 4 communicating with the above-described engine 2. Specifically, as illustrated in FIG. 4, the catalyst member 5 is disposed on the downstream side of the exhaust pipe 4. The kind of the catalyst member 5 is not particularly limited. The catalyst member 5 may contain the noble metal, such as platinum (Pt), palladium (Pd), and rhodium (Rh) as a catalyst. Note that a downstream side catalyst member may further be disposed in the exhaust pipe 4 in the downstream side of the filter member 6. The specific configuration of such catalyst member 5 does not characterize the present disclosure, and thus, a detailed description is omitted here.

The filter member 6 is the filter catalyst according to the embodiment and is disposed on the downstream side of the catalyst member 5. The filter member 6 can trap the particulate matter (hereinafter, simply referred to as “PM”) contained in the exhaust gas, and has a catalytic ability.

The exhaust gas purification device is not limited to the one having the configuration illustrated in FIG. 4, it is possible to use any configuration insofar as it includes the filter catalyst according to the embodiment. For example, each of the members, shapes of portions, and structures of the exhaust gas purification device 1 may be changed. While in the example illustrated in FIG. 4, the catalyst member 5 is disposed in the upstream side of the filter catalyst 6, the catalyst member may be omitted. This exhaust gas purification device 1 is particularly appropriate as a device that converts (or decomposes) the harmful components in the exhaust gas relatively high in exhaust air temperature, such as a gasoline engine. However, not limited to the usage to convert (or decompose) the harmful component in the exhaust gas of the gasoline engine, the exhaust gas purification device according to the embodiment can be used in various kinds of usages to convert (or decompose) the harmful components in the exhaust gas discharged from another type of engine (for example, diesel engine).

### EXAMPLES

The following describes the embodiment with test examples. Note that the present disclosure is not limited by the following test examples.

### Example 1

### (Substrate)

As the substrate, a wall-flow type substrate (total length 80 mm, thickness of partition wall: 200 μm, cell density: 300 cells/inch²) made of cordierite was prepared.

(Preparation of Slurry for Oxygen Occlusion Portion)

1 part by mass of an alumina binder and an ion exchanged water were added to 32 parts by mass of ceria-zirconia composite oxide (CeO₂—ZrO₂ composite oxide, CeO₂ content: 20 mass %) as the oxygen occlusion material and 8 parts by mass of alumina powder (γ-Al₂O₃), and they were sufficiently stirred and wet-ground. This prepared a slurry for the oxygen occlusion portion (1). The slurry for the oxygen occlusion portion (1) had viscosity of 100 mPa·s.

(Preparation of Slurry for Catalyst Portion)

After a nitric acid Rh solution as a noble metal catalyst solution was impregnated in the alumina powder (γ-Al₂O₃), drying and sintering were performed to prepare a Rh supporting powder that supported Rh at a proportion of 1.2 mass %. 1 part by mass of an alumina binder and an ion exchanged water were added to 18 parts by mass of this Rh supporting powder, and they were sufficiently stirred and wet-ground. This prepared a slurry for the catalyst portion (1). The slurry for the catalyst portion (1) had viscosity of 2500 mPa·s. The slurry for the catalyst portion (1) was prepared such that its viscosity became higher than the viscosity of the slurry for the oxygen occlusion portion (1).

After a nitric acid Pd solution and an ion exchanged water were impregnated in 7 parts by mass of alumina powder (γ-Al₂O₃) and 12 parts by mass of ceria-zirconia composite oxide (CeO₂—ZrO₂ composite oxide), drying and sintering were performed to prepare a Pd supporting powder that supported Pd at a proportion of 2 mass %. 1.8 parts by mass of barium sulfate, 1 part by mass of an alumina binder, and an ion exchanged water were added to 19 parts by mass of this Pd supporting powder, and they were sufficiently stirred and wet-ground. This prepared a slurry for the catalyst portion (2). The slurry for the catalyst portion (2) had viscosity of 2500 mPa·s. The slurry for the catalyst portion (2) was prepared such that its viscosity became higher than the viscosity of the slurry for the oxygen occlusion portion (1).

(Formation of Oxygen Occlusion Portion and Catalyst Portion)

After the slurry for the oxygen occlusion portion (1) was supplied inside the wall-flow type substrate from the inlet-side end portion, the extra slurry was removed by vacuuming from the end portion on the opposite side of the supplied side. Afterwards, the slurry was dried.

Next, after the slurry for the catalyst portion (1) was supplied inside the wall-flow type substrate from the inlet-side end portion, the extra slurry was removed by vacuuming. Afterwards, the slurry was dried. Next, after the slurry for the catalyst portion (2) was supplied inside the wall-flow type substrate from the outlet-side end portion, the extra slurry was removed by vacuuming. Afterwards, the slurry was dried, and the substrate was sintered.

The mass of the catalytic metal (Rh) was 0.15 g per 1 L of volume of the substrate, the mass of the catalytic metal (Pd) was 0.4 g, and the mass of the oxygen occlusion material was 47 g.

Thus, a filter catalyst E1 having the oxygen occlusion portion and the catalyst portion formed inside the partition wall was manufactured.

### Example 2

A filter catalyst E2 was manufactured similarly to Example 1 except that ceria-zirconia composite oxide (CeO₂ content: 40 mass %) was used instead of ceria-zirconia composite oxide (CeO₂ content: 20 mass %).

### Comparative Example 1

Ceria-zirconia composite oxide (CeO₂ content: 20 mass %), Rh/alumina carrier powder (1), and an alumina binder were added to a pure water, and they were sufficiently stirred and wet-ground. This prepared the slurry C1.

Ceria-zirconia composite oxide (CeO₂ content:20 mass %), the above-described Pd supporting powder, and an alumina binder were added to a pure water, and they were sufficiently stirred and wet-ground. This prepared the slurry C2.

In preparing these slurries, an amount of each material was adjusted such that the same amount as the coated amount in Example 1 of each material was coated.

Next, after the slurry (C1) was supplied from the inlet-side end portion into the substrate, the extra slurry was removed by vacuuming, and dried. Next, after the slurry (C2) was supplied from the outlet-side end portion into the substrate, the extra slurry was removed by vacuuming, and dried. Afterwards, the substrate was sintered.

Thus, the filter catalyst C1 having the catalyst and oxygen occlusion portions that include the catalytic metal and the oxygen occlusion material in a mixed state formed inside the partition wall was manufactured.

### Comparative Example 2

A filter catalyst C2 was manufactured similarly to Comparative Example 1 except that ceria-zirconia composite oxide (CeO₂ content: 40 mass %) was used instead of ceria-zirconia composite oxide (CeO₂ content: 20 mass %).

[Evaluation]

### (Sem Image)

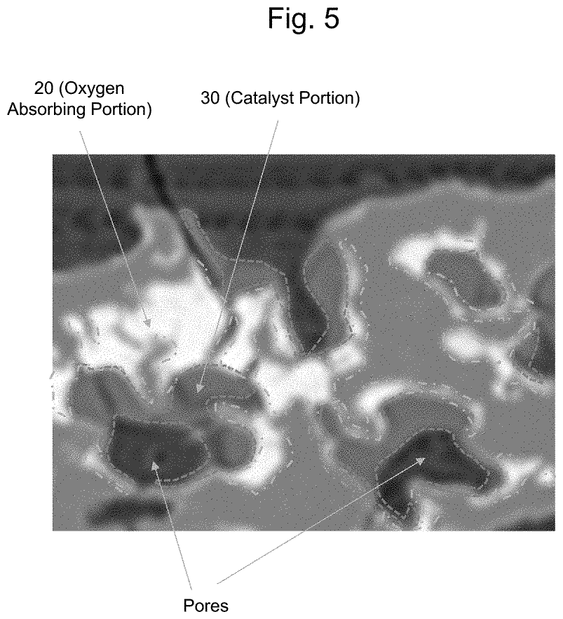

FIG. 5 illustrates an image of a distribution state of a coating component measured by using an electron probe micro analyzer (EPMA). While FIG. 5 is a monochrome image, a component analysis image of cerium and alumina determined constituting members of respective dark and light portions. In FIG. 5, bright portions surrounded by a one dot chain line are the oxygen occlusion portion 20. Relatively dark portions surrounded by a dashed line are the catalyst portion 30. The darkest portions are the pores. Other portions are wall portions of the porous structure. As illustrated in FIG. 5, the oxygen occlusion portion was disposed on the wall surface of the porous structure, the catalyst portion was formed on the oxygen occlusion portion. The surface of the catalyst portion was exposed to a space where the exhaust gas flows.

(50% Purification Temperature)

Purification performances (50% purification temperatures) of the obtained filter catalysts E1 to E2 and C1 to C2 were evaluated.

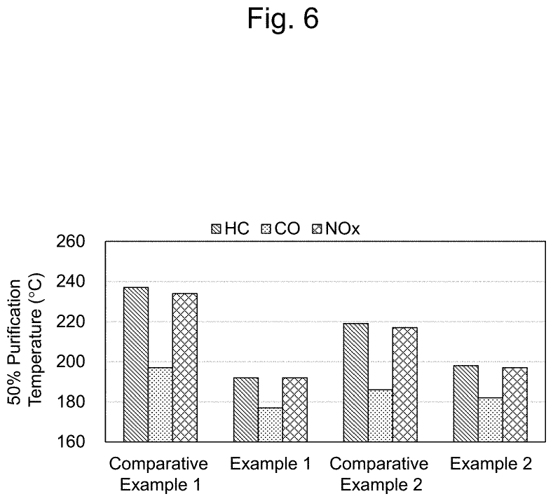

Purification rates (conversion rates) of an HC gas, a CO gas, or a NOx gas when the temperature rise of 100° C. to 600° C. (temperature rising rate 20° C./minute) were continuously measured, and 50% purification temperatures in the respective gases were measured. Here, 50% purification temperatures are gas temperatures at catalyst inlets when the conversion rates of the respective gases reached 50%. The results are shown in FIG. 6. FIG. 6 is a graph that illustrates 50% purification temperatures of the filter catalysts E1 to E2 and C1 to C2 obtained in Examples and Comparative examples.

As illustrated in FIG. 6, the filter catalysts E1 and E2 in Examples are confirmed to have higher purification performances than the filter catalysts C1 and C2 in Comparative examples have.

(Oxygen Occlusion Amount)

Oxygen occlusion capabilities (oxygen occlusion amount) of the obtained filter catalysts E1 to E2 and C1 to C2 were evaluated.

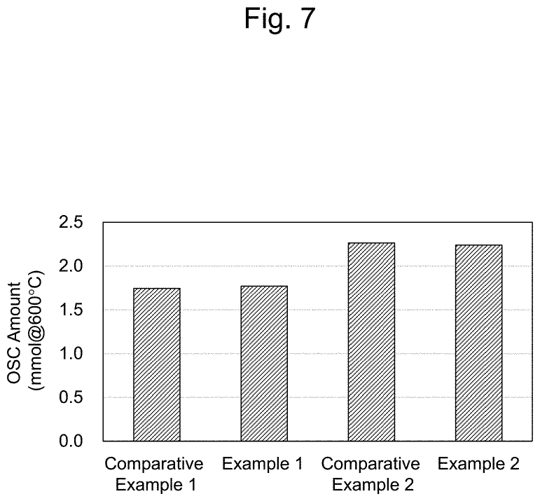

Column-shaped samples (diameter 30 φ, length 80 mm) were cut out from the obtained filter catalysts. An N₂ gas containing 1% of O₂ and an N₂ gas containing 2% of CO were alternately switched at intervals of two minutes and flown onto these samples at a flow rate of 20 L/minute and at a temperature of 600° C., and oxygen concentrations in the model gas were measured. This measured the oxygen occlusion amounts. Repeating this for five times, and a mean value of the oxygen occlusion amounts at two to four times was employed as a measurement value. It is illustrated in FIG. 7.

As illustrated in FIG. 7, the filter catalysts E1 and E2 in Examples had approximately the same oxygen occlusion amounts as those of the respectively corresponding filter catalysts C1 and C2 in Comparative Examples. This confirmed that disposing the oxygen occlusion material on a lower side of the catalyst portion does not particularly lower the oxygen occlusion capability.

The person skilled in the art can use the above-described description in order to maximally exploit the present disclosure. The patent claims and embodiments disclosed in this description are simply explanatory and exemplary, and should be construed as not limiting the range of the present disclosure in any sense. With the assistance of the present disclosure, the details of the above-described embodiment can be changed without departing from the basic principle of the present disclosure. In other words, various kinds of modifications and improvements of the embodiment specifically disclosed in the above-described description are within the range of the present disclosure.

### DESCRIPTION OF SYMBOLS

1 Exhaust gas purification device
2 Internal combustion engine (engine)
3 Exhaust manifold
4 Exhaust pipe
5 Catalyst member
6 Filter catalyst
7 ECU
10 Substrate
12 Inlet-side cell
12a Sealing portion
14 Outlet-side cell
14a Sealing portion
16 Partition wall
16a Front surface of partition wall (wall surface facing the inlet-side cell 12)
16b Back surface of partition wall (wall surface facing the outlet-side cell 14)
17 Communication hole
18 Non-communication hole
20 Oxygen occlusion portion
30 Catalyst portion
100 Filter catalyst

What is claimed is:

1. A filter catalyst comprising
a wall-flow type substrate that includes an inlet-side cell, an outlet-side cell, and a partition wall, the inlet-side cell having an open end portion on an exhaust gas flow-in side and a closed end portion on an exhaust gas flow-out side, the outlet-side cell being adjacent to the inlet-side cell and having an open end portion on the exhaust gas flow-out side and a closed end portion on the exhaust gas flow-in side, the partition wall having a porous structure and interposing between the inlet-side cell and the outlet-side cell; and
an oxygen occlusion portion and a catalyst portion dispersed and disposed in the porous structure,
wherein the oxygen occlusion portion is disposed on a wall surface of the porous structure, and
wherein the catalyst portion is disposed on the oxygen occlusion portion, and the catalyst portion has a surface exposed to a space where an exhaust gas flows including a communication hole.

2. The filter catalyst according to claim 1,
wherein the oxygen occlusion portion and the catalyst portion are each dispersed over the whole porous structure.

3. An exhaust gas purification device comprising
the filter catalyst according to claim 1.

4. A method for manufacturing the filter catalyst according to claim 1, comprising:
dispersing and disposing a slurry for an oxygen occlusion portion containing an oxygen occlusion material and a solvent in the partition wall;
disposing a slurry for a catalyst portion containing a catalytic metal, a catalyst carrier, and a solvent in the porous structure where the slurry for the oxygen occlusion portion is disposed and on the slurry for the oxygen occlusion portion; and
sintering the substrate including the slurry for the oxygen occlusion portion and the slurry for the catalyst portion.

5. The method for manufacturing the filter catalyst according to claim 4, comprising drying the slurry for the oxygen occlusion portion before disposing the slurry for the catalyst portion in the porous structure.

6. A method for manufacturing a filter catalyst, comprising:
preparing a wall-flow type substrate that includes an inlet-side cell, an outlet-side cell, and a partition wall, the inlet-side cell having an open end portion on an exhaust gas flow-in side and a closed end portion on an exhaust gas flow-out side, the outlet-side cell being adjacent to the inlet-side cell and having an open end portion on the exhaust gas flow-out side and a closed end portion on the exhaust gas flow-in side, the partition wall having a porous structure and interposing between the inlet-side cell and the outlet-side cell;
dispersing and disposing a first slurry containing an oxygen occlusion material and a solvent in the partition wall;
disposing a second slurry containing a catalytic metal, a catalyst carrier, and a solvent in the porous structure where the first slurry is disposed and on the first slurry; and
sintering the substrate including the first slurry and the second slurry.

7. The method for manufacturing a filter catalyst according to claim 6,
wherein a viscosity of the second slurry is greater than a viscosity of the first slurry.
